(19) United States
(12) Patent Application Publication
(10) Pub. No.: US 2010/0027839 A1
(43) Pub. Date: Feb. 4, 2010

(54) SYSTEM AND METHOD FOR TRACKING MOVEMENT OF JOINTS

(75) Inventor: Munish Sikka, Naperville, IL (US)

Correspondence Address: FITCH EVEN TABIN & FLANNERY, 120 SOUTH LASALLE STREET, SUITE 1600, CHICAGO, IL, 60603-3406, US

(73) Assignee: THINK/THING, Chicago, IL (US)

(21) Appl. No.: 11/831,733

(22) Filed: Jul. 31, 2007

(51) Int. Cl. G06K 9/00

(52) U.S. Cl. 382/103

(57) ABSTRACT

A first image is obtained. At least one moving object indicated by the at least one image is selected. At least one joint that is associated with the at least one moving object is identified. At least one second image including the at least one moving object with the at least one joint is obtained and the movement of the at least one joint is tracked in a three-dimensional space.

### RELATED APPLICATION

“System and Method for Visually Representing an Object to a User” by Munish Sikka having Attorney's Docket No. 90589 being filed on the same day as the present application, the contents of which are incorporated herein by reference in their entirety.

### FIELD OF THE INVENTION

The field of the invention relates to tracking the movement of objects (e.g., inanimate and living) and, more specifically, to tracking the movement of the joints of objects.

### BACKGROUND OF THE INVENTION

Motion capture techniques have been used in various fields to track moving objects. For example, military organizations have used motion capture techniques to track moving objects targeted by missiles. In another example, doctors and other medical professionals have used motion capture techniques to analyze the gait of human subjects. In still another example, the entertainment industry has used these techniques to capture the motion of subjects for use in films.

The above-mentioned techniques all utilize the placement of physical markers on the object to be tracked. In one example, markers present on the object emit or reflect light that is captured in a system that includes hundreds of cameras. In other example, the markers emit a magnetic field that can be detected. In still another example, markers on the object sense movement and the orientation of the object using potentiometers and accelerometers. Mechanical systems can also be used where an exoskeleton is mounted on the subject. In this case, the joints of the exoskeleton can measure their own rotation and transmit the information to a computer system for analysis.

Unfortunately, various problems exist with all of the above-mentioned marker-based approaches. For instance, the use of markers requires that a costly and cumbersome marker be attached to the object. The markers must be physically fixed to the object and can often impair movement. In many cases (such as in entertainment applications), the subject (e.g., an actor or actress) must wear a suit that is attached to the marker and the suit can be hot and uncomfortable for the subject to wear.

The specific approaches mentioned above suffer from additional disadvantages. Visual approaches were expensive to implement in many areas where objects moved (e.g., open areas). In these systems, the cameras were usually fixed thereby limiting the area of possible motion of the subject. As for magnetic systems, the presence of metallic objects in the vicinity of the tracking area sometimes corrupted the data obtained from the markers. Inertial systems were highly inaccurate. As for mechanical approaches, the exoskeleton was typically cumbersome and uncomfortable to wear. Additionally, the range of motion was limited and the exoskeleton could not mimic the exact movement of the subject. Furthermore, all of the above-mentioned systems required the use of multiple cameras.

### SUMMARY OF THE INVENTION

Approaches are provided that track the movement of joints in objects. These approaches do not require the use and wearing of markers or other equipment that can be used to demarcate joints and, in many cases, are accomplished with the use of an image capture device. The approaches described herein can be used in both open and confined spaces, and are cost effective to implement.

In many of these embodiments, at least one first image is obtained. At least one moving object indicated by the image is selected either automatically or by the user. At least one joint that is associated with the at least one moving object is then identified. At least one second image including the moving object with the joint is obtained and the movement of the joint is tracked in a three-dimensional space.

In some of these embodiments, a pixel signature associated with the at least one joint may be formed and the pixel signature is stored in memory. The pixel signature may indicate the area of the joint from the first images. The pixel signature may be use to track joint movement.

When identifying the joint, a plurality of edge vectors may be determined and at least one edge vector intersection point of the plurality of edge vectors may also be determined. The intersection of the vectors identifies a joint or endpoint of the object. Other approaches may also be used to identify joints from the images.

The moving object may be a variety of subjects. For example, the moving object may be a human, a bridge (e.g., having truss-like construction), or a train. Other examples of moving objects are possible.

The approaches described herein can be applied to a variety of situations. For example, when the moving object is a train, the joints between cars may be tracked and their movement analyzed to determine if the train has become derailed. In another example, when the moving object is a bridge (e.g., when the bridge is subject to heavy loading), movement of joints in the bridge (e.g., where the trusses connect) may be tracked and analyzed to determined whether the bridge is structurally sound or if a structural member has failed or could fail.

The images used can be obtained from a variety of image capture devices. For example, the images may be obtained from a single image capture device. In other examples, multiple image capture devices can be used. The image capture devices themselves may be any type of device that can capture any type of image using any means such as video cameras, digital cameras, or cameras on satellites. Other types of cameras or image capture devices (e.g., using other technologies such as ultrasound, infrared) may also be used.

Thus, approaches are provided that track the movement and position of joints. These approaches can be utilized to track the movement of any type of joint (e.g., human, mechanical) in any type of space (e.g., open, confined). These approaches are also easy and cost effective to use, for example, sometimes utilizing only a single camera. These approaches are also user-friendly, for instance, not requiring the wearing of uncomfortable items (e.g., body suits) or the attachment of markers.

### BRIEF DESCRIPTION OF THE DRAWINGS

FIG. 1 is a block diagram of a system for tracking a moving joint according to various embodiments of the present invention;

FIG. 2 is a flowchart of an approach for tracking movement of a joint according to various embodiments of the present invention;

FIG. 3 is a flowchart for determining moving objects in an image according to various embodiments of the present invention;

FIG. 4 are diagrams showing the determination of moving objects in an image according to various embodiments of the present invention;

FIG. 5 is a flowchart of one approach for determining moving joints according to various embodiments of the present invention;

FIGS. 6a-g and FIGS. 7a-g are diagrams illustrating one approach for determining joints in an object according to various embodiments of the present invention;

FIG. 8 is a flowchart of one approach for distinguishing between objects according to various embodiments of the present invention;

FIGS. 9a-b are diagrams illustrating one approach for distinguishing between objects according to various embodiments of the present invention;

FIG. 10 is a flowchart of one approach for tracking the movement of a joint according to various embodiments of the present invention;

FIG. 11 comprises diagrams illustrating one approach for tracking the movement of a joint according to various embodiments of the present invention; and

FIG. 12 comprises a flowchart of an approach for tracking joints on a moving object according to various embodiments of the present invention.

Skilled artisans will appreciate that elements in the figures are illustrated for simplicity and clarity and have not necessarily been drawn to scale. For example, the dimensions and/or positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DESCRIPTION OF THE PREFERRED EMBODIMENTS

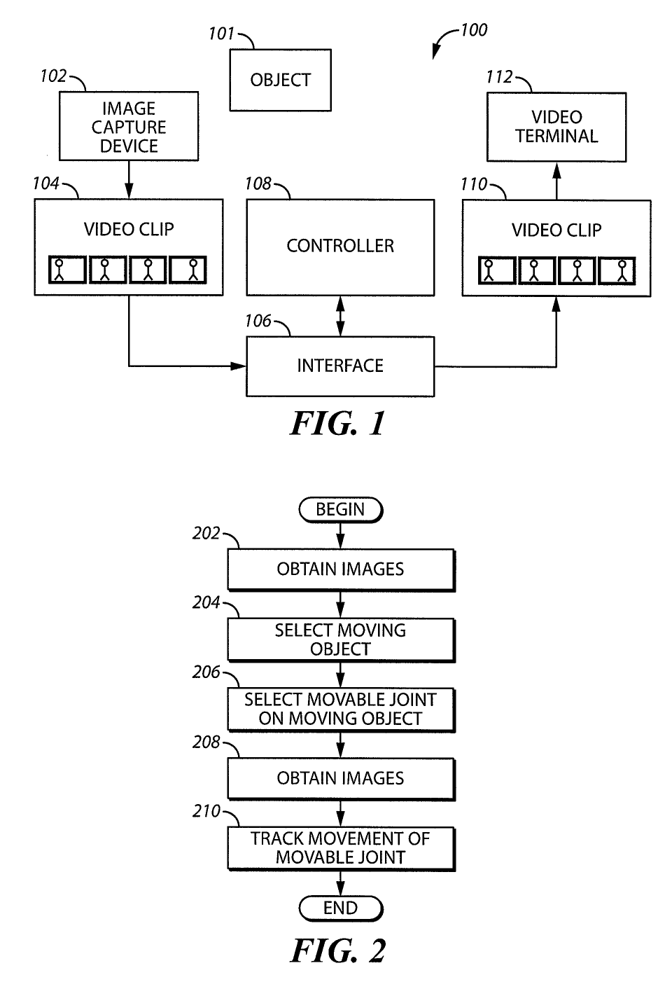

Referring now to FIG. 1, a system 100 for tracking joints of an object is described. The system 100 includes an image capture device 102, which supplies a video clip (or series of image frames) 104 of an object 101 to an interface 106. The interface 106 is coupled to a controller 108. The controller creates and the interface transmits a modified video clip 110 for display to a user on a display 112.

The image capture device 102 may be any suitable device that is used to acquire images. In this respect it may be a video camera, a digital camera, or a camera on a satellite. Other types of cameras or image capture devices (e.g., using other technologies such as ultrasound, infrared) may also be used.

The interface 106 is any type of device or combination of devices that utilizes any combination of hardware and programmed software to convert signals between the different formats utilized by the image capture device 102, controller 108, and display 112. For example, the interface 106 converts the raw video clips into a format usable by the controller 108. The controller 108 is any type of programmed control device (e.g., a microprocessor) capable of executing computer instructions. Additionally, the controller 108 may include any type of memory or combination of memory devices.

The images of the object 101 in the video clip 110 used can be obtained from a variety of different image capture devices. For example, the images may be obtained from a single image capture device. In other examples, multiple image capture devices can be used to obtain the images. The image capture devices themselves may be any type of device that can capture any type of image using any technology such as video cameras, digital cameras, or cameras on satellites.

In one example of the operation of system of FIG. 1, one or more first images (frames) of the moving object 101 are obtained and placed in a video clip 104. For example, the video clip 104 includes a plurality of frames (including the one or more first frames) that show motion of the object 101. The object indicated by the first image is selected. In one example, the controller 108 identifies the object 101 as moving by comparing the position of the object in frames of the video clip 104. In another example, a user may make a selection of the object on the display 112. The controller 108 is arranged and configured to determine at least one joint that is associated with the object 101 by analyzing video clips received from the image capture device 102.

After the joint has been identified, one or more second images including the object 101 are obtained by the image capture device 102 and the movement of the joint is tracked in a three-dimensional space. In this regard, a pixel signature associated with the at least one joint may be formed and stored in a memory at the controller 108. The pixel signature is formed from one frame of the plurality of first plurality of images and indicates the area of the joint. Additionally, the pixel signature may be associated with the moving joint on an object.

The pixel signature is taken from one frame of a plurality of images and may be updated in each subsequent frame of the plurality of images and, as mentioned, is used to track joint movement.

In one application of these approaches, the joints and their positions and orientations in three-dimensional space are recorded over a time span. Then, the set of data indicating the positions and orientations of the joints are compared to positions and orientations of joints of known people, and, if a match is determined, the identity of a person is determined.

When identifying the joint, and as explained elsewhere in this specification, a plurality of edge vectors may be determined by the controller 108 and at least one edge vector intersection point of the plurality of edge vectors may also be determined by the controller 108. The controller 108 identifies an intersection of the vectors, which, in turn identifies a joint on the object 101. In one approach, only those vector intersections whose angles are changing in subsequent image frames are identified as joints. Vector intersections whose angles are constant (within a threshold) are determined to be end points.

The moving object 101 may be a variety of subjects. For example, the moving object 101 may be a human, a bridge, or a train. Other examples of moving objects are possible.

After processing each frame of the video clip, each frame of a modified video clip 110 may be formed by the controller 108 and displayed to the user at the display 112. In one example, the modified video clip 110 shows the joints of the object. In other examples, other types of information can be displayed to the user at the terminal 112. For example, the absolute position of joints may be indicated and warning messages displayed based upon the movement of joints.

In this regard, the approaches described herein can be applied to a variety of situations. For example, when the moving object 101 is a train, the joints between cars may be tracked and analyzed to determine if the train has become derailed. In another example, when the moving object 101 is a bridge, movement of joints in the bridge may be tracked and analyzed to determined whether the bridge is structurally sound. In yet another example, the joints of a robotic arm may be tracked over time while they are being manually moved by a person. Once the positions, rotations, and orientations of the joints have been recorded over time, that data can be used to train the robotic arm using the recorded set of animation data (joint positions, orientations, and rotations over time). The robotic arm can therefore be programmed simply by moving the arm.

Referring now to FIG. 2, one example of an approach for tracking joints is described. At step 202, images are obtained. For example, the images may be obtained from an image capture device such as a digital camera, video camera, or a camera positioned on a satellite. The image capture device may be a single or multiple image capture device that utilizes any type of technology. At step 204, the moving object is selected or determined. For example, the image selection may be made by comparing frames of a video clip to identify moving objects and stationary objects. Image processing techniques (e.g., pixel value subtraction between neighboring frames) can be used to identify (or highlight) the moving objects and remove stationary objects.

At step 206, a joint is automatically determined on the moving object. The joint may be selected in the image according to various approaches, for example, by using edge vectors as described herein. Other approaches can also be used. At step 208, additional images are obtained. At step 210, movement of the joints on the object is tracked, for example using a pixel signature and in three-dimensional space (although, in other examples, other forms of tracking may occur in space).

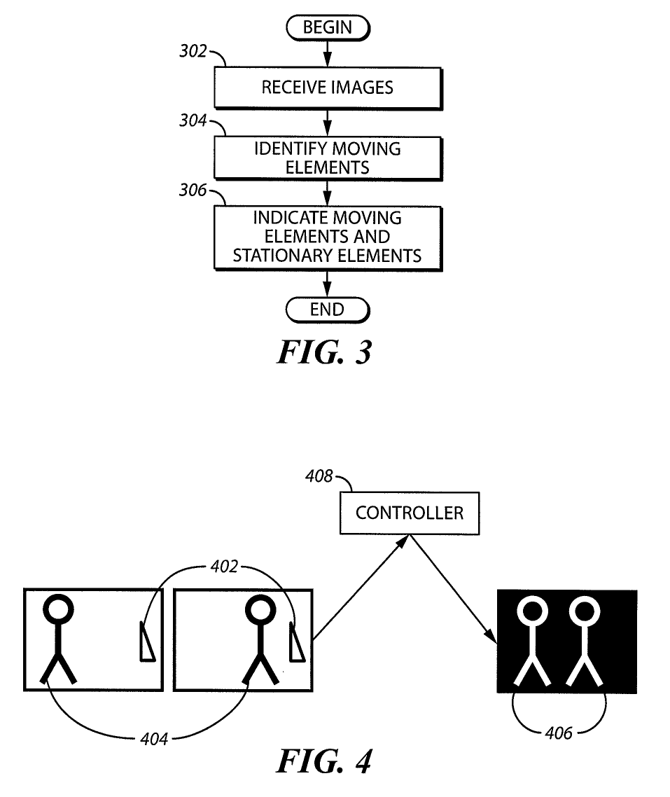

Referring now to FIG. 3, one example of an approach for determining a moving object is described. At step 302, images are received from an image capture device, for example, from a camera. At step 304, moving elements in the images are determined. For example, frames of a video clip may be compared to identify which pixels move from frame to frame. At step 306, the moving elements are identified and the stationary elements are identified using techniques such as pixel subtraction. In one example, the moving elements are highlighted and the stationary elements are removed to form a video clip where only the moving elements are shown.

Referring now to FIG. 4, a controller 408 is used to identify moving objects 404 in video images as compared to stationary objects 402 in the same images. As shown, the controller 408 identifies the moving and stationary objects and removes the stationary objects to form a new image where only stationary objects 406 are shown.

The new image may be created and only moving objects are identified. A pixel may have a value of one for the object and a zero value otherwise. In other words, the object may be a highlighted area of pixels whose values are one while the remaining parts of the image have pixel values of zero.

It will be appreciated that the approaches illustrated in FIGS. 3 and 4 are only one example of approaches for identifying moving and non-moving objects. Other approaches may also be used.

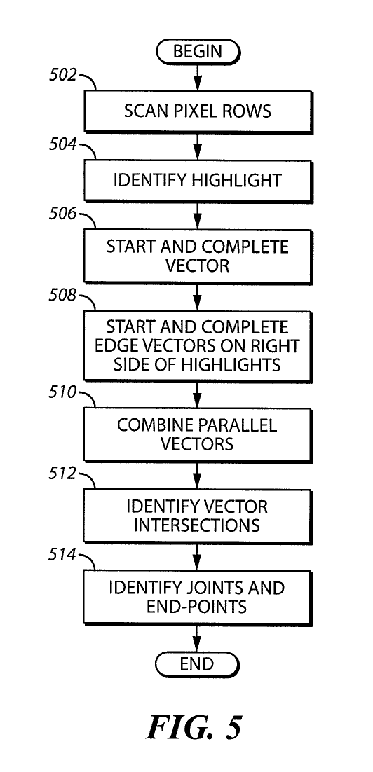

Referring now to FIG. 5, one example of an approach for identifying joints is described. This approach determines a vector representation of edges of an object. The intersection of vectors whose angles are changing in subsequent frames identifies the movable joints in the object. Vectors whose angles are constant identify endpoints of the object. It will be appreciated that other techniques besides those using vectors may also be used to identify joints.

At step 502, rows of pixels of an image are scanned. For example, an image may be created where only moving objects are identified. A pixel may have a binary one value for the object and a binary zero value otherwise. In other words, the object may be a highlighted area of pixels whose value is one while the non-moving objects have pixel values of zero. At step 504, a highlighted area (i.e., areas of ones) are identified by scanning the image from left to right.

At step 506, a vector is started when the left edge of the object is detected. The scan continues until a change in direction of the vector is detected or the edge is discontinued (i.e., an endpoint is detected). After the first vector is completed, at step 508, the remaining edge vectors are completed and the set of vectors completely identify all edges of the object. The resultant set of vectors will likely have parallel vectors that define parallel edges of the object. At step 510, these parallel vectors are combined.

At step 512, vector intersections are identified. The vector intersections define joints and, at step 514, the vector intersections that define joints and endpoints are identified.

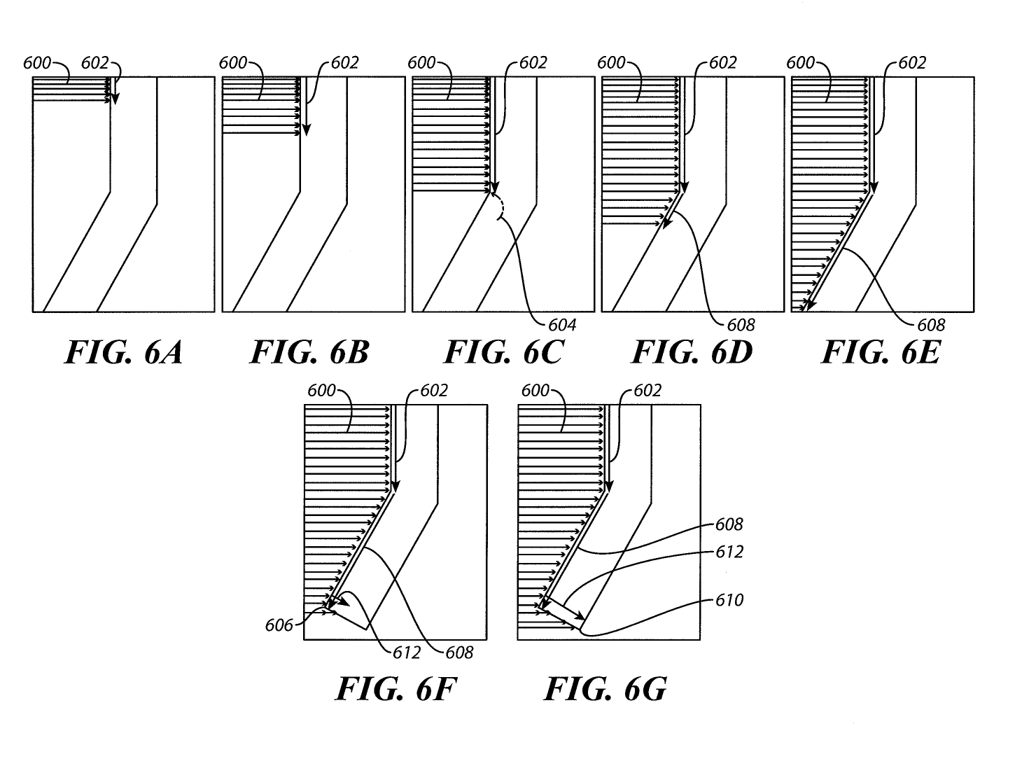

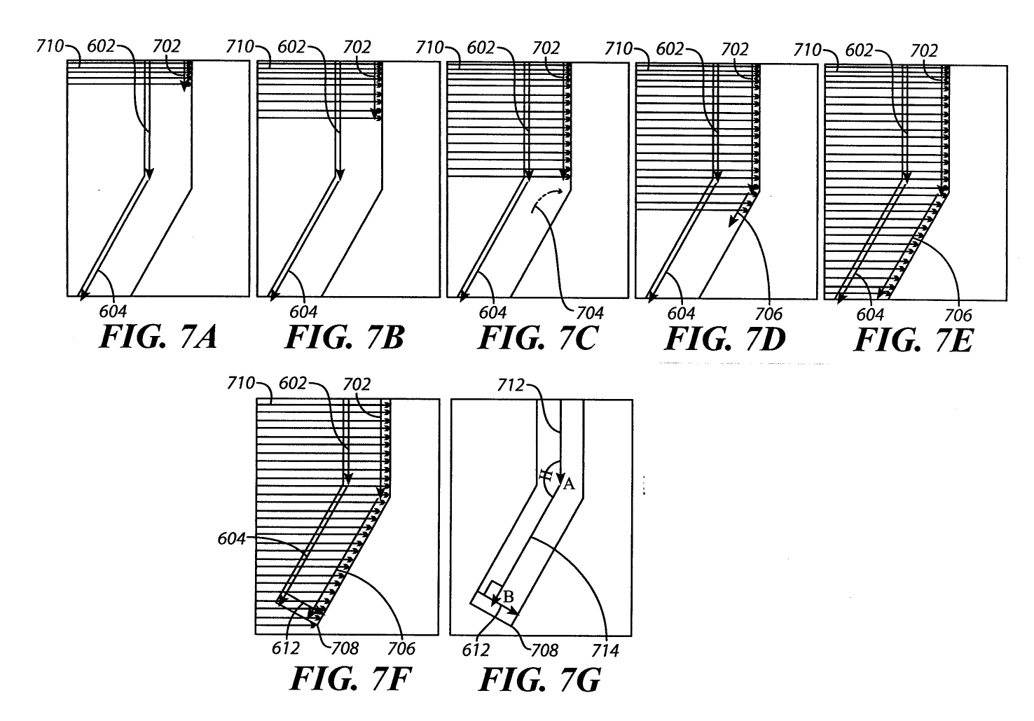

Referring now to FIGS. 6a-g and FIGS. 7a-g, one example of identifying joints using vectors is described. In these examples, the image to be processed includes rows of pixels with binary zero value representing background space and pixels with binary values of one representing the moving object(s).

Referring now to FIGS. 6a-g, scan lines 600 are applied to rows of pixels in the images and initially determine the left edge of the object (by finding the first pixel with a one value at the left edge of the object), and this initial left edge is represented by a vector 602 (FIG. 6a). The scan lines 600 are continued to be applied, and the edge vector 602 grows until point 604 is reaches (FIGS. 6b-c). The scan lines 600 are applied again until an endpoint 606 is reached (FIGS. 6d-6f). The scan lines 600 define a second vector 608. The endpoint 606 is determined when the scan lines 600 indicate the edge is reached. The scan lines 600 are applied again and a vector 612 is determined (FIG. 6g). The scan lines 600 indicate that an end point 612 is reached. The scan also indicates the end of the vector 612. After the completion of the scanning shown in FIGS. 6a-g, vectors 602, 608, and 612 have been determined and the left side and bottom of the object have been defined.

Referring now to FIGS. 7a-7g, the continued scan of the object is described. Scan lines 710 are now applied to the image and to the right side of the object. The lines 710 are applied to the right edge to form a vector 702 (FIGS. 7a-7c). The end of the vector 702 is indicated when the scan lines 710 detect the point 704 (FIG. 7c). At this time, the scan lines 710 are applied until another end point 708 is detected (FIGS. 7d-f). In this case, the vector 706 is formed. At this point, the object's left, right, and bottom edges are defined that are indicated by the vectors 602, 604, 612, 702 and 706.

Duplicate vectors are removed in the image shown in FIG. 7g. Specifically vectors 602 and 702 are parallel and are combined into vector 712. Vectors 604 and 706 are parallel and are combined as vector 714. Vector 612 is not duplicated and is kept. The intersections of vectors 712 and 714 are identified as joints (their angles change over subsequent frames) and the intersections with the vector 612 are identified as endpoints.

It will be appreciated that the approaches shown in FIGS. 6a-g and 7a-h are one example only of determining the presence and position of the joints of a moving object and other approaches may be used.

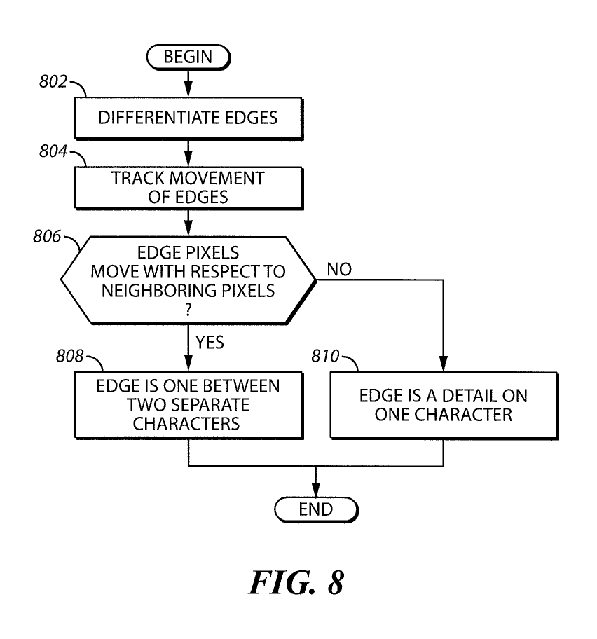

Referring now to FIG. 8, one example illustrating the identification of separate moving characters in an image is described. In one example, two people may be moving closely together and the system determines that two moving objects exist. At step 802, edges in the object are differentiated. At step 804, the movement of the edges is tracked. At step 806, it is determined if the edges have moved with respect to neighboring pixels. If the answer is affirmative, at step 808, the edge is identified as an edge between two separate moving objects or characters. If the answer is negative, the edge is identified as a detail in the object or character.

Various techniques can be used to determine the interior and exterior edges of objects or characters. For example, bump mapping techniques can be used where each pixel is given a normal mapped value, for instance between 0 and 255. Whether two edges are different objects or an element on an object depends upon further computations. If the edge pixels have moved with respect to the neighboring pixels from the previous frame, this indicates that the edge exists on two separate objects. If the edge pixels have not moved with respect to the neighboring pixels, this indicates a variation of a property (e.g., color) of an object. Once all inner edges have been marked, the exterior edges can be used to create convex objects using convex hull algorithms and to identify separate objects or characters.

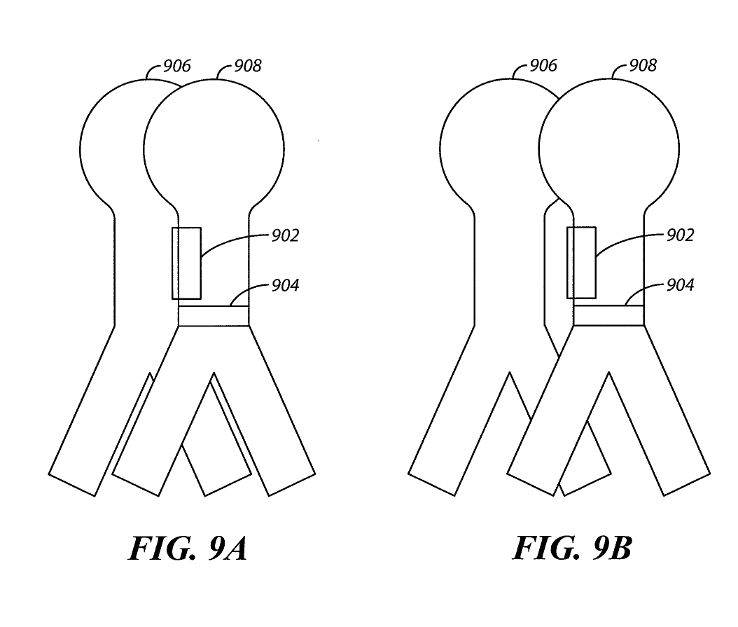

Referring now to FIGS. 9a and 9b, one example of determining separate moving objects is described. A first object (a first person) 906 is near a second object (second person) 908. The first person moves with the second person. An edge is identified in area 902. Another potential edge is identified in area 904. The areas 902 and 904 are monitored. Since, the edge in the area 902 moves between frames and, consequently, with respect to all neighboring pixels, the area 902 is identified as including an edge and the two objects 906 and 908 are identified as being separate moving objects. However, any differences in the area 904 between frames (e.g., are a result of changes in shadow or other factors) have substantially no movement between adjacent pixels. Consequently, the area 904 is considered to be an area of a single object and is not considered to be indicative of multiple objects.

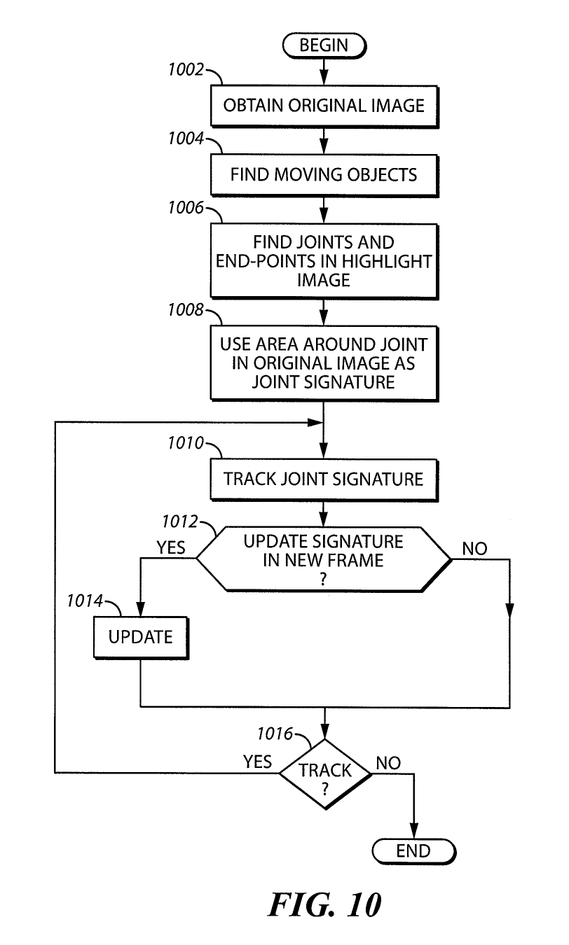

Referring now to FIG. 10, one example of an approach for tracking joints is described. It will be appreciated that other approaches may also be used, for example, approaches not utilizing signatures. At step 1002, the original image (unprocessed to show joints) is obtained. At step 1004, moving objects are identified in the image and at step 1006 the joints and endpoints are identified in the original image. For example, an area having of predetermined pixel dimensions is selected.

At step 1008, the area around the joint in a single frame is identified as a joint signature. At step 1010, the motion of the joint is tracked from frame to frame by comparing subsequent frames. The pixels are compared to determine (within a predetermined tolerance) whether an area can be determined to be the area of the joint.

At step 1012, it is determined if an update of the joint signature is needed. For example, after every frame, the new frame may contain the new joint signature. Consequently, changing light and pattern will not cause the system to fail to identify and track the joint area. If the answer is affirmative, at step 1014, the joint signature is updated. If the answer is negative, execution continues at step 1016.

At step 1016, it is determined if it is desired to continue tracking. If the answer is affirmative, execution continues at step 1010 as described above. If the answer is negative, execution ends.

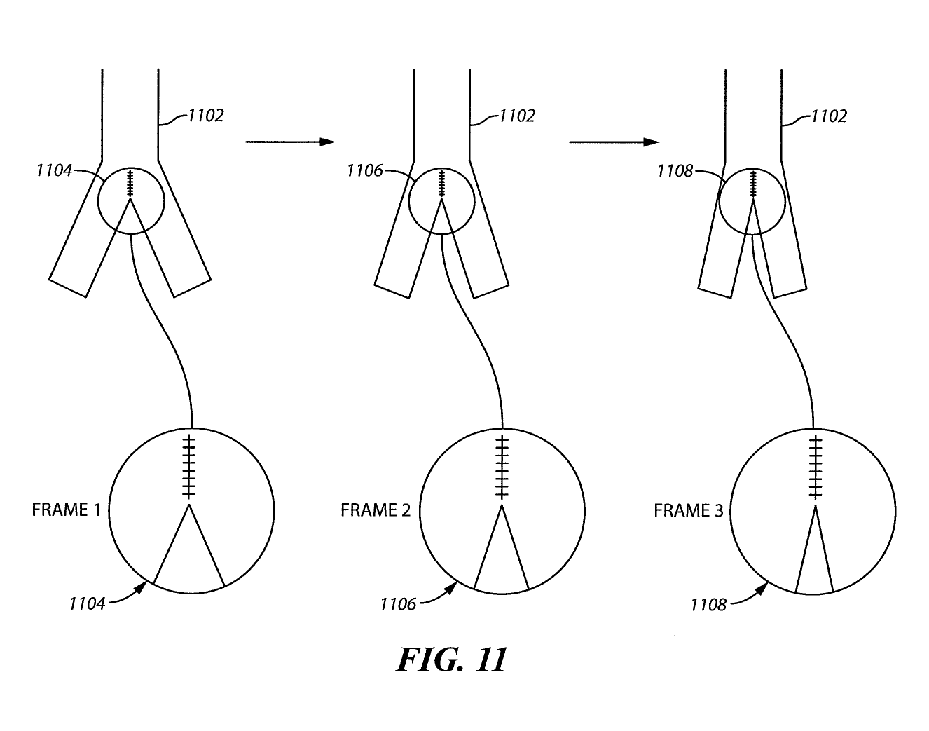

Referring now to FIG. 11, one example of tracking the movement of the joint area is shown. An area 1102 of a person is used as a pixel signature area. The pixel signature area changes from a first pixel area 1104, to a second pixel area 1106, to a third pixel signature area 1108 as the person moves and the image changes. In this example, the signature changes from frame to frame. For example, the image 1106 shows only slight variations from image 1104 and consequently the signature is changed from 1104 to 1106. Similarly, image 1108 shows slight variations from 1106, so the signature is changed. Consequently, the movement of a joint can be tracked over time and from frame to frame. Additional information (e.g., joint location) can be obtained from the identified joint as it moves and this information can be used and/or processed for other purposes. It will be appreciated that the techniques discussed with respect to FIGS. 10 and 11 are one example of tracking the movement of joints and other approaches are possible.

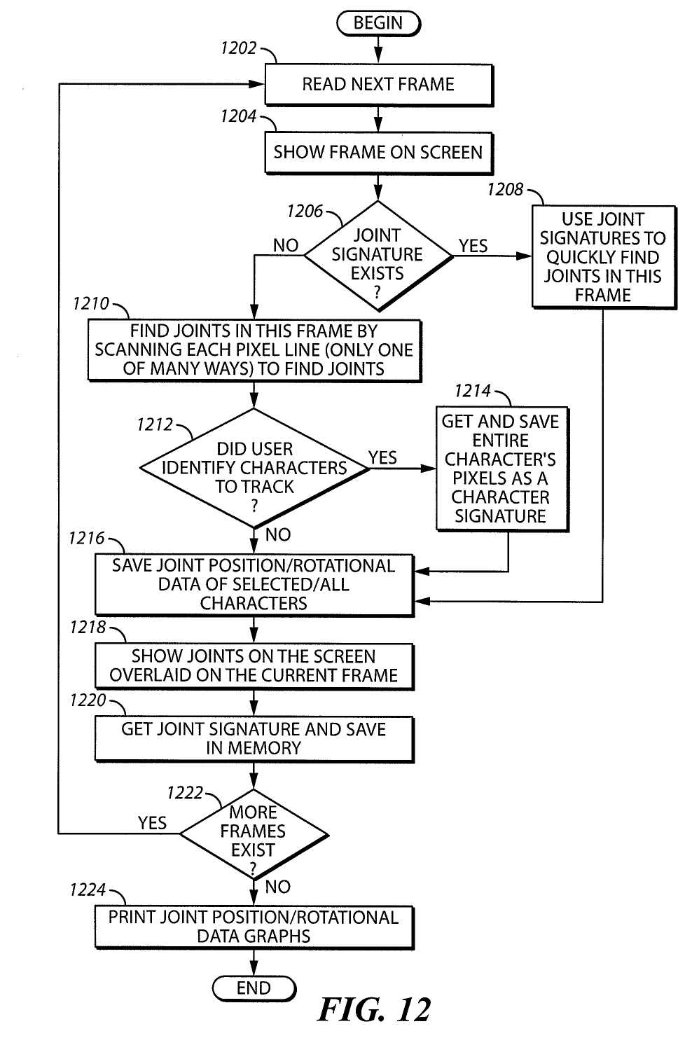

Referring now to FIG. 12, an approach for tracking joints on a moving object is described. At step 1202, the next frame is obtained. At step 1204, the frame is displayed on a display screen. At step 1206, it is determined if a joint signature exists. If the answer is negative, execution continues with step 1208 where the existing joint signature is used to quickly find the joint. Execution continues with step 1216 as described below.

If the answer at step 1206 is affirmative, at step 1210 the system finds the joints in the frame. For example, the vector analysis techniques described elsewhere in this specification may be used. At step 1212, it is determined if the user identified the character (or object) to track. If the answer is affirmative, at step 1214 the system obtains and saves the character's pixels as the signature. At step 1216, the joint position/rotational data of the characters are saved. At step 1218, all the joints are shown on the screen overlaid on the current frame. With this step, the real image of the object is overlaid with the joint data. At step 1220, the system obtains the joint signature and stores this in memory. At step 1222, it is determined if more frames exist. If the answer is affirmative, control returns to step 1202. If the answer is negative, at step 1224 joint position and data graphs may be printed. Execution then ends.

Thus, approaches are provided that track the movement of joints. These approaches can be utilized to track the movement of any type of joints (e.g., human, mechanical) in any type of space (e.g., open, confined). These approaches are also easy and cost effective to use, for example, sometimes utilizing only a single camera. These approaches are also user-friendly, for instance, not requiring the wearing of uncomfortable items (e.g., body suits) or the attachment of markers.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of determining the position of a joint comprising:
obtaining at least one first image;
selecting at least one moving object indicated by the at least one first image;
identifying at least one joint that is associated with the at least one moving object; and
obtaining a at least one second image including the at least one moving object with the at least one joint, and tracking movement of the at least one joint in a three-dimensional space.

2. The method of claim 1 further comprising forming a pixel signature associated with the at least one joint and storing the pixel signature in memory.

3. The method of claim 2 further comprising associating the signature with a moving joint on a character.

4. The method of claim 3 further comprising comparing the pixel signature to the at least one second image to determine if a match exists.

5. The method of claim 1 wherein identifying at least one joint comprises determining a plurality of edge vectors and identifying at least one edge vector intersection point of the plurality of edge vectors.

6. The method of claim 1 wherein the at least one moving object comprises an object selected from a group comprising: a human; a bridge; and a train.

7. The method of claim 1 wherein the object comprises a train and further comprising determining whether the train has become derailed based upon the tracking.

8. The method of claim 1 wherein the object comprises a bridge and further comprising determining whether the bridge is structurally sound based upon the tracking.

9. The method of claim 1 wherein obtaining the at least one first image comprises obtaining the images from at least one image capture device.

10. A system for determining the movement of a joint comprising:
an image capture device;
an interface having an input and an output; and
a controller coupled to the image capture device, the controller being arranged and configured to obtain at least one first image from the image capture device and receive a selection stamp from the input of the interface indicating at least one moving object indicated in the at least one first image, the controller being further configured and arranged to identify at least one joint that is associated with the at least one moving object, the controller being further configured to obtain at least one second image including the at least one moving object from the image capture device and track movement of the at least one joint in a three-dimensional space and present an indication of the movement at the output of the interface.

11. The system of claim 10 wherein the image capture device is a device selected from a technology comprising: digital image technology, ultrasound, and infrared.

12. The system of claim 10 wherein the input of the interface is coupled to display for allowing a user to select the at least one moving object.

13. The system of claim 10 wherein the output of the interface is coupled to a display for allowing the indication to be presented to the user.

14. The system of claim 10 wherein the controller is further configured and arranged to form a pixel signature associated with the at least one joint and store the pixel signature in a memory.

15. The system of claim 14 wherein the controller is further configured and arranged to associate the signature with a moving joint on a character.

16. The system of claim 15 wherein the controller is further configured and arranged to compare the pixel signature to the at least one second image to determine if a match exists.

17. The system of claim 10 wherein the at least one moving object is an object selected from a group comprising: a human, a bridge, and a train.
